(19) United States
(12) Patent Application Publication
(10) Pub. No.: US 2003/0217041 A1
(43) Pub. Date: Nov. 20, 2003

(54) Intergated managing method for local area network switching devices

(76) Inventor: Guiquan Mao, Shenzhen City (CN)

Correspondence Address: SCHNADER HARRISON SEGAL & LEWIS, LLP, 1600 MARKET STREET, SUITE 3600, PHILADELPHIA, PA, 19103

(21) Appl. No.: 10/401,356

(22) Filed: Mar. 28, 2003

(30) Foreign Application Priority Data
Mar. 28, 2002 (CN) 02108606.0

(51) Int. Cl. G06F 7/00

(52) U.S. Cl. 707/1

(57) ABSTRACT

An integrated managing method for LAN switching devices. The switching device broadcasts a register message including switching device address identification on a port connected to a managing device, the managing device executes a register operation , and sends back a register response message, the switching device sends a handshaking message to the managing device after receiving a successful register response message, and the managing device sends back the communicating response message. If the switching device does not receive the response message within a designated time, it indicates that communication is interrupted and the register operation starts again. During the communicating, process the managing device manages the switching device, and the switching device sends back the response message to the managing device according to the operation result. The need to assign IP addresses is thus reduced or eliminated.

### FIELD OF THE INVENTION

The present invention relates to a managing method for network devices, more particularly to an integrated managing method for switching devices on a Local Area Network (LAN).

### BACKGROUND OF THE INVENTION

With the rapid development of LANs, more and more LANs switching devices, such as Ethernet switches, have been used. In order to save the cost of device management and maintenance, integrated management for the decentralized devices is needed. Traditional managing methods for switching devices on LANs are realized mainly by Simple Network-Management Protocol (SNMP). According to SNMP, Transmission Control Protocol or Internet Protocol (TCP/IP) is run between network management devices and managed switching devices of LANs to implement the managing and managed processes. Management is realized by agent process of the managed device side and management process of the managing device side. Exchange of managing information is carried out by the following five messages: a getting parameter request message (get-request), which is used to take one or more parameters from the agent process; a getting next parameter request message (get-request), which is used to take the next parameter of one or more parameters; a setting request message, which is used to set one or more parameters of the agent process; a getting response message, which is used to respond to the above three messages, and one or more parameter returns; a trap message, automatically sent by the agent process, is used to inform the management process of a management request. The five messages are sealed in data packages of a user datagram protocol (UDP) in the process of management, and are transferred over the LAN.

Traditional integrated managing methods for switching devices on a Local Area Network are based on the TCP/IP protocol. Therefore, managed switching devices need to have independent IP addresses to properly managet and maintain switching devices on a LAN. However, if each switching device of a network is allotted a management IP address, precious IP address resources are wasted when a large amount of switching devices are connected to a LAN. Accordingly, there is a need for an integrated managing method for switching devices on a Local Area Network while saving IP address resources.

### SUMMARY OF THE INVENTION

An integrated managing method for switching devices on a Local Area Network according to the present invention comprises the steps of:

(1) the switching device broadcasting a register message including address identification of a present switching device on a port connecting a managing device to the present switching device, the managing device executing a register operation after receiving the message, and sending a register response message to the present switching device;

(2) sending a handshake message from the switching device to the managing device at a specified time after receiving a successful register response message; the managing device sending a communicating response message to the switching device after receiving the handshake message; the switching device receiving the communicating response message; communicating with the managing device, and in the communication process, the managing device managing the switching device;

(3) determining whether the time of the handshake message is within a designated time;

(4) if not, returning to step (2), otherwise going to step (1) to continue.

In an exemplary embodiment of the invention step (1) further comprises the step of: the switching device inserting location information of the switching device into the register message after receiving the register message, and transmitting it.

In a further embodiment of the invention, before the registration process of step (1) is complete, the switching device sends a request for a configuring data message to the managing device, the managing device sends configuring data to the switching device after receiving the request message.

Step (2) may further comprise the step of: when the switching device does not receive the communicating response message within the designated time, starting the register operation again.

The managing device and switching device exchange information through messages with a special format (Internet Group Management Protocol Message, IGMP), the message includes a public message heading, managing messages and Ethernet heading, preferably with label 802.1Q;

The public message heading comprises the following fields:

version number, which is used to indicate the version of the current managing protocol;

C, which is used to indicate whether the current message is a response message or command message;

Type, which is used to differentiate integrated management from two-layered multicast group control message;

F, which is used to identify whether the frame serial number is effective;

R, which is used to identify whether the check sum is effective;

B, which is used to identify whether the feedback word is effective;

the frame serial number, which is used to indicate the message serial number according to each network switching device;

check sum, which is used to check message data;

length of message, which is used to identify length of the message;

feedback word, which is used to indicate response the untouched feedback data by message;

media access control (MAC) for switching device (LAN Switch): which is used to identify managing MAC addresses of the switching device;

the first transmitting port number, the second transmitting port number, the third transmitting port number, and the fourth transmitting port number, are respectively used to record the inlet port number after messages are transmitted by the switching device.

The managing message comprises:

home command word, which is used to act as a home command word of managing message;

sub command word, which is used to act as a sub-command word of managing message;

length of content, which is used to record the length of content of the managing message;

content of the managing message, which is used to record the parameter and data carried in the managing message.

Compared with existing integrated managing methods for network switching devices, in the two-layered network environment of the present invention, the switching device broadcasts a register message including address identification of a present switching device on a port connected to the managing device. After the switching device is successfully registered, the switching device sends a handshake message to the managing device. The managing device sends a communicating response message to the switching device after receiving the handshake message, therefore a time-dependant communicating process between the managing device and the switching device is realized. In the time communicating process, the managing device operates on data query, data assignment and software upgrade according to requirements. Therefore, compared with existing integrated managing methods for network switching devices, a prominent advantage of the present invention may be realized in that precious IP address resources may be saved by integrating management and maintenance of network switching devices without configuring IP addresses for the switching device.

### BRIEF DESCRIPTION OF THE DRAWINGS

The invention is best understood from the following detailed description when read with the accompanying drawings.

FIG. 1 is a flowchart of an illustrative embodiment of a method of the present invention;

FIG. 2 is a processing chart showing change of the transmitting port according to an illustrative embodiment of the invention

### DETAILED DESCRIPTION OF THE INVENTION

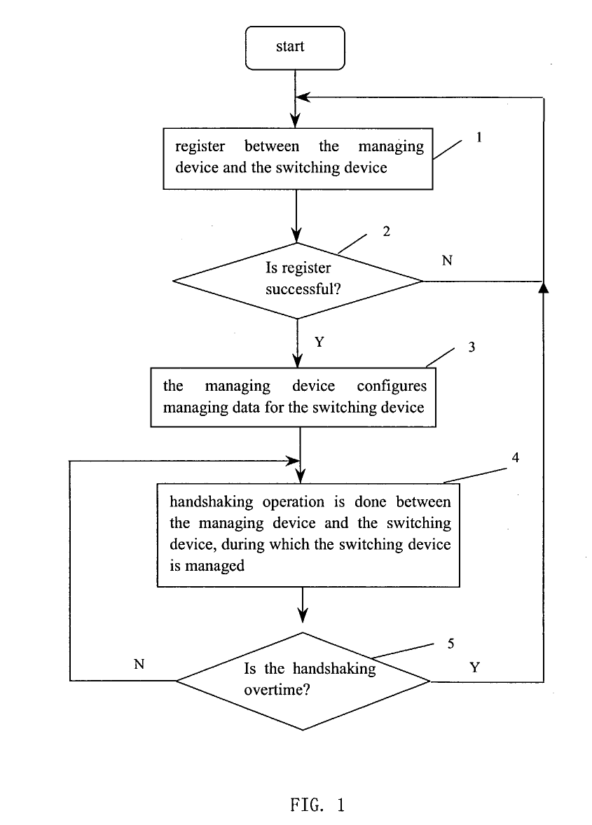

FIG. 1 is a flowchart of an illustrative embodiment of a method according to the present invention. Integrated management of switching devices on a two-layered network is realized by the embodiment of FIG. 1. The embodiment of FIG. 1 operates in the Client/Server mode, i.e. the managing device acts as Server, and the switching device acts as Client. Therefore, the managing Server software runs on the gathering device at a higher network position, and the Client runs on the managed switching devices such as a network switch. A managing device can manage several switching devices simultaneously. To make the managing devices and the switching devices communicate by exchanging messages, the present invention provides a message in a special format comprising: an Ethernet heading with the label 802.1Q, a public message heading and a managing message. The public message heading and managing message will now be further described in detail according to the embodiment.

The public message can be carried behind the Ethernet heading, as shown in the following table:

| | | | | | | | | |
|---|---|---|---|---|---|---|---|---|
| 31 30 29 28 | 27 | 26 25 24 | 23 | 22 | 21 | 20 19 18 17 16 | 15 14 13 12 11 10 9 8 | 7 6 5 4 3 2 |

| | | | | | | | | |
|---|---|---|---|---|---|---|---|---|
| 0 | version | C | type | F | R | B | reserved | frame serial number |

| 1 | check sum | | length of message | |
|---|---|---|---|---|
| 2 | feedback word | | MAC for switching device | |
| 3 | MAC for switching device | | | |
| 4 | the first | the second | the third | the fourth |
| | transmitting port | transmitting port | transmitting port | transmitting port |
| | number | number | number | number |

| | |
|---|---|
| 5 | Reserved |

Wherein:

The version number may occupy 4 bits and is used to indicate the version current managing protocol.

The C field, may occupy 1 bit and is used to indicate whether the current sage is a response message or a command message; for example, 0—represents command (or request), 1—represents response (or responding).

The type field may occupy 3 bits and is used to differentiate between integrated management and two-layered multicast group control messages; for example, 000 may represent integrated management of the switching devices, 001 may represent multicast transmission for the switching devices.

The F field may occupy 1 bit and identifies whether the frame serial number is effective;, for example, the frame serial number is used when F=.

The R field may occupy 1 bit and identifies whether the check sum is effective; for example, the check sum is not used when R=0; and the check sum is used when R=1.

The B field may occupy I bit and identifies whether the feedback word is effective for example, the feedback word is not used when B=0; and the feedback word is used when B=1.

The frame serial number field may occupy 16 bits and is used to identify a message serial number according to each network switching device.

The length of the check sum may occupy 16 bits and is used to check message data.The calculating method may be similar to IP and UDP, and the R field determines whether it is effective.

The length of message field may occupy 16 bits and is used to identify a length of the message.

The feedback word field, which is used to indicate response the untouched feedback data by message, may occupy 16 bits, untouched feedback data when responding messages;

The media access control (MAC) for switching device field is used to managing MAC address of the switching device.

The first transmitting port number, the second transmitting port number, the third transmitting port number, and the fourth transmitting port number, are respectively used to record the inlet port number after the messages are transmitted by the switching devices. The physical positions of the switching devices can be determined by the fields. The effective range of port numbers is related to the port amount of some switching device. If the port amount of a switching device is PORT_NUM, when the switching device transmits the IGMP message to a switching device of a next layer, the range of transmitting port number is between 0 and PORT_NUM-1;

The reservation field may occupy 4 bytes and is used to expand the function of messages. For example, if a cascade connection layer of the switching device is more than 5, the field can be used to define the transmitting port number.

The managing message , which is carried under the public message in practical applications, comprises the following fields:

| | | | |
|---|---|---|---|
| home command | sub command | length of | content of the |
| word | word | content | managing message |

The home command word may occupy 1 bit and is used to act as a home command word of the managing message.

The sub command word may occupy 1 bit and is used to act as a sub command word of the managing message.

The length of content field may occupy 2 bits and is used to record the length of content of the managing message.

The content of the managing message is used to record a parameter and the data carried in the managing message. The exact format and size may change according to the application appliance, and the length can be determined by the length of content field. Usually, with the limitation of length of Ethernet communications, the field is no more than 1468 bytes: from 0 to 1468 bytes.

As seen from above, implementing the present invention according to FIG. 1 comprises two processes: the first is the register of a switching device, through which a managing channel is established between a managing device and a switching device; the second is the process of communicating. Integrated management for switching devices is finished by communicating between the managing device and the switching device. The steps are the following:

In step 1, the switching device broadcasts a register message including address identification of a present switching device on the port connecting the managing device. The managing device executes a register operation after receiving the register message, and sends a register response message to the switching device. The switching device inserts location information of the switching device in the register message after receiving the register message and transmits it. The registration process between the switching device and the managing device is an alternate one to complete registration of physical addresses and legal confirmation from the switching device. In this step, when power is turned on or reset, the switching device will automatically broadcast a register message on a predetermined port connecting the managing device. The message includes device identification of the switching device. If the switching device does not receive a register response message from some managing device within a designated time, e.g., 30 seconds, then it will try to register again at designated intervals, such as 30 seconds until some managing device supplies a register response message.

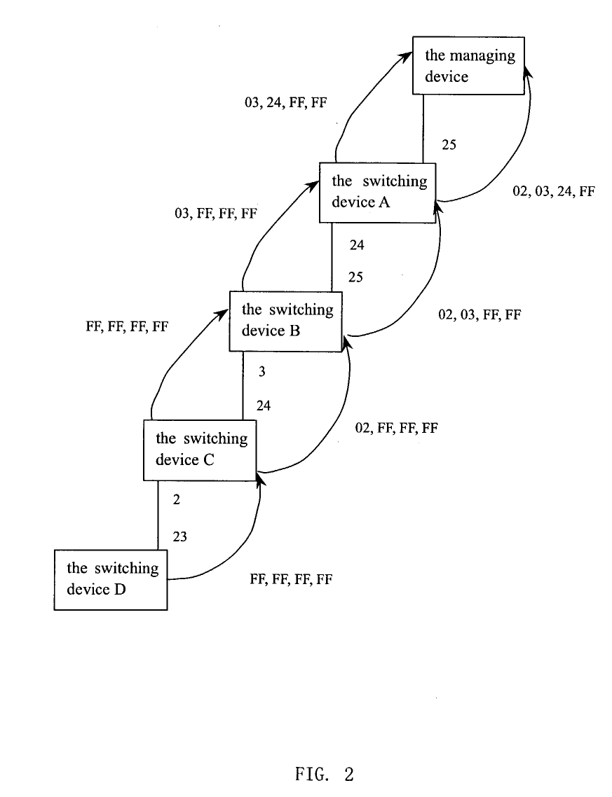

In step 1, when receiving the register message, the switching device processes the register message first, then transmits it, because the switching device is connected to the ports of the managing device in cascade connection. The managing device determines the physical position of the switching device in the network according to the register message of the switching message, and the physical position is provided by stage by stage serial processing ports of upper-layer switching devices connected to lower-layer switching devices. Thus, the register message must be processed first by the lower-layer switching devices, which insert information into the register message. Then the register message is transmitted to an upward switching device and is reprocessed until the message reaches the managing device (referring to FIG. 2). In FIG. 2, when the switching device D sends a register or multicast handshake message, the transmitting ports in public message heading are FF, FF, FF, FF. The switching device receives the message at port 2 and inserts “2” in the message and sends it to device B. The transmitting port changes the message to 02, FF, FF, FF. After receiving the message, the switching device B inserts the receiving port 3 in themessage and sends it to the switching device A. The transmitting port changes to 02, 03, FF, FF. After receiving the message, the switching device A inserts the receiving port 24 in the message and sends it to the managing device. The transmitting port changes to 02, 03, 24, FF. The managing device inserts its own receiving port after receiving the message, thus remembering the position of device D.

After the switching device receives the register response message, step 2 is implemented and whether the register operation is successful according to the response message is determined. If not, step 1 is implemented to register again. If yes, the switching device is henceforth in charge of only the managing device, ignoring other possible switching devices in the network, and records the port of the switching device from which the register response message comes. The managing device will not try to re-register until continuous trouble appears between the two.

In step 3 of FIG. 1, after successful registration,, the managing device distributes configuration data to the switching device. In this step, the managing device examines whether the configuration data of the switching device at this physical position is stored in itself. If yes, the configuration data is distributed; if no, the managing device distributes the order of using configuration default data to assign to the switching device. After the assignment is finished, a configuring end message is reported, indicating whether the assignment is successful. At the same time the assignment process is finished, the number of the communication port of the switching device with the managing device is written. In step 4 of FIG. 1, the switching device begins the operation of time communicating with the managing device. In this step, the switching device automatically sends handshake messages to the managing device in timing to ensure that the channel between the two is normal. Handshake messages comprise single-cast communicating and multicast communicating; there is certain time interval between the single-cast communicating and normal multicast communicating. In a process of normal communicating, the managing device manages the switching device; the switching device receives commands from the managing device and processes those commands , and returns a processed result to the managing device.

In step 4, because topology of the switching device may change during registration and use of single-cast communication may not find the switching device multicast communication may be used. When the switching device transmits, the multicast handshake message needs to insert position information in the register message, then transmit it.

In the process of normal communicating of step 4, step 5 is implemented. In step 5, the switching device determines whether the communication time is over time, due to system interrupts (e.g., trouble is caused by a network connection or device). If the managing device does not receive a communication response message from the switching device within a designated time, such as 30 seconds, after sending a communication request, , it means communication has been interrupted. The switching device stops the operation of communicating, changes the register state of the switching device to unregistered, and the registration process starts over. If communicating time is not over time, then return to step 4.

The operation of the managing device managing the switching device mainly comprises querying data of the switching device, a configuration process and a managing process for the multicast group.

According to an illustrative embodiment of the invention the querying data of the switching device, and configuring process are initiated by the managing device, as follows:

(61) the managing device distributes a configuration parameter message or querying parameter message to the switching device according to the need of managing;

(62) the switching device receives the message, and determines the type of the message; if it is a configuration parameter message, turn to step (63), if it is querying parameter message, turn to step (64);

(63) examining whether the configuration data of the message is right; if the configuration data is wrong, fill in an error code in the corresponding returning record; if the configuration data is right, the configuration data is assigned to the switching device and the assigned result is reported to the managing device, then the operation ends;

(64) examining whether the querying parameter of the message is right; if the parameter is wrong, filling in an error code in the corresponding returning record; if the parameter is right, the switching device is queried according to the parameter, and the queried result is reported to the managing device, then the operation ends.

The managing process of the multicast group comprises the processes of a user entering a multicast group, a user leaving a multicast group and the switching device transmitting a two-layered multicast message;

the process of a user entering a multicast group can be realized by the following steps according to an illustrative embodiment of the inventions:

A1) the server sends a general query message in Internet Group Management Protocol (IGMP) to side ports of all users; destination MAC address of the is special, always 01-00-5E-00-00-01; destination IP address of the message is 224.0.0.1;

A2) the client intercepts all IGMP messages. When receiving a general query message in IGMP from Server, e.g., the destination MAC address is the message 01-00-5E-00-00-01, the Client transmits the message to side physical ports of all upward users;

A3) after all users receive the general query message in IGMP, the user wishing to receive some information of multicast group sends an IGMP REPORT; destination IP address of the IGMP response message is an IP of a special multicast group, known as a D type IP address, and the destination MAC address is a multicast MAC address corresponding to the special multicast group, whose format is 01-00-5E-**-**-**;

A5) after receiving the IGMP REPORT from the user, the Client directly sends it to the Server transparently;

A6) after receiving the IGMP REPORT from the user, the Server determines whether the user can be admitted according to the MAC address, VLAN ID of the user and multicast IP address that the user wants to enter. If not, losing it, otherwise the Server transmits an IGMP message to the Client that a special user is entering a special multicast group.

A7) The Client intercepts all IGMP messages; when the Client receives an IGMP message that a special user is entering the special multicast group, the following steps are performed according to an illustrative method of the invention:

look for a physical port number of the user according to the MAC address of the user of the IGMP message;

look for its own CAM table according to the multicast MAC address of the IGMP message; if a list item of the transmission of the multicast group is found in the table, the Client inserts a physical port number of the user in the transmitting interface table; if a list item of transmission of the multicast group is not found in the table, a new list item of transmission of the multicast group is added, the upward port connecting Server and physical port number of the user are inserted in the transmitting interface table.

Thus, the process of a user entering the multicast group ends.

According to an illustrative embodiment of the invention, the process of the user leaving the multicast group refers to the following steps:

B1) Server sending general query message in IGMP to side ports of all users in timing, Client will transmit the general query message in IGMP to all users;

B2) if receiving the IGMP REPORT, the Server will process it according to the process of the user entering a multicast group;

B3) when the Server sends a general query message many continuous times but does not receive any IGMP REPORT relating to the multicast group from some port having entered the multicast group, then a member of the multicast group will not exist in the port, therefore, the Server will delete the port from the transmitting interface table of the multicast group, and send an IGMP message deleting the special multicast group to the port;

B4) when receiving an IGMP message to delete the special multicast group, the Client deletes the transmission table relating to the multicast group;

B6) for the message leaving the multicast group, which is automatically sent by the user, the Client sends it to the Server transparently, then the Server processes the operation of the user's leaving;

B7) the Server sending a special multicast group query message.; if the Server does not receive a special REPORT message within a designated time, then it indicates that the user of the special multicast group does not exist at the port, therefore the Server will delete the port from the transmitting interface table of the multicast group, and send an IGMP message deleting the special multicast group to the port;

B8) when receiving the IGMP message deleting the special multicast group, the Client deletes the transmission table relating to the multicast group;

Because multicast services (such as VOD and audio service) for users mostly belong to one-way applications, only receiving multicast information is considered but not sending the multicast message upward. Transmitting the multicast message is accomplished by the Server with the cooperation of the Client. The process of the Client transmitting the multicast message comprises:

C1) the Server transmitting the multicast message to the switching device;

C2) the Client being responsible for a two-layered multicast transmission, the Client looks for its own CAM table according to a MAC address of the multicast group; if a corresponding list item is not found, it indicates that the multicast group does not exist in the CAM table, and the Client loses the multicast message; otherwise, the Client transmits to other ports except those receiving the multicast message according to a multicast transmitting interface table, therefore the multicast message can be received by the user.

A Practical operation of the managing device managing a switching device further comprises the process of data upgrading.

What is claimed is:

1. An integrated managing method for switching devices of Local Area Network, comprising:
(A) a switching device broadcasting a register message including an address identification of the switching device to a port connected to a managing device, the managing device executing a register operation after receiving the register message, and sending a register response message to the switching device;
(B) the switching device sending a handshake message to the managing device after receiving a successful register response message, the managing device sending a handshaking response message to the switching device, after the switching device receives the handshake message response, the switching device handshaking with the managing device, and the managing device managing the switching device during the handshaking process;
(C) determining whether the handshaking occurs within a specified time, if not, returning to step (B), otherwise e returning to step (A).

2. The integrated managing method for switching devices of Local Area Network of claim 1, wherein said step (A) further comprises:
an upper switching device inserting location information of the switching device to the register message after receiving the register message from the lower switching device, and transmitting the message to the upper switching device.

3. The integrated managing method for switching devices of Local Area Network of claim 1, wherein said step (A) and step (C) comprise:
when the data needs to be configured, the switching device sending a request message to configure data to the managing device, the managing device sending configured data to the switching device after receiving the message.

4. The integrated managing method for switching devices of Local Area Network of claim 1 wherein said step (B) further comprises:
when the switching device does not receive the handshaking message response within a predetermined period, restarting the register process.

5. The integrated managing method for switching devices of Local Area Network of claim 4, wherein:
the information transmitting between the managing device and the switching device is realized by a message comprising a public message heading, managing message and Ethernet heading;

6. The integrated managing method for switching devices of Local Area Network of claim 5 wherein the public message heading comprises one or more of the following fields:
version number, to indicate a version of current managing protocol;
C, to indicate whether a current message is response message or command message;
Type, to differentiate integrated management from two-layered multicast group control message;
F, to identify whether a frame serial number is effective;
R, to identify whether a check sum is effective;
B, to identify whether a feedback word is effective;
frame serial number, to indicate a message serial number according to each network switching device;
check sum, to check message data;
length of message, to identify length of a message;
feedback word, to indicate response the untouched feedback data by message;
media access control (MAC) for switching device (LAN Switch): used to identify managing MAC addresses of the switching device;
a first transmitting port number, a second transmitting port number, a third transmitting port number, and a fourth transmitting port number, to record an inlet port number after messages are transmitted by the switching device;

7. The integrated managing method for switching devices of Local Area Network of claim 5 wherein the managing message comprises:
home command word, to act as a home command word of managing message;
sub-command word, to act as a sub-command word of managing message;
length of content, to record length a of content of the managing message;
content of the managing message, to record parameters and data carried in the managing message.

8. The integrated managing method for switching devices of Local Area Network of claim 1,
wherein: in step (B), the managing device managing the switching device, comprises querying data of the switching device, and performing a configuration process according to the following steps:
(D) the managing device distributing a configuring parameter message or querying parameter message to the switching device according to the need of managing;
(E) the switching device receiving the message, determining the type of the message, if it is the configuring parameter message, processing to step (F), if it is querying parameter message, processing to step (G);
(F) examining whether the configuring data of the message is correct, if the configuring data is not correct, filling in an error code in a corresponding returning record; if the configuring data is correct, the switching device being assigned with the configuring data, and the assigned result being reported to the managing device, then ending the operation;
(G) examining whether the querying parameter of the message is correct, if the parameter is not correct, filling in an error code in a corresponding returning record; if the parameter is correct, the switching device being queried according to the parameter, and the queried result being reported to the managing device, then ending the operation.

9. The integrated managing method for switching devices of Local Area Network of claim 1, wherein in step (B), the managing device managing the switching device, comprises:
a managing process of a r multicast group, comprising: a user entering the multicast group, the user leaving the multicast group and the switching device transmitting a two-layered multicast message.

10. The integrated managing method for switching devices of Local Area Network of claim 9, wherein the process of the user entering the multicast group comprises:
H) the managing device sending a general query message in Internet Group Management Protocol to ports at a user side; the switching device transmitting the message to user side ports;
I) the user sending a REPORT message, the switching device sending upward to the managing device after receiving the REPORT message from user; and
J) the managing device determining whether the user can enter the desired multicast group according to the REPORT message from the user, if no, losing the REPORT message, otherwise transmitting a message of the user entering the desired multicast group to the switching device, the switching device allowing the user enter the desired multicast group after receiving the message.

11. The integrated managing method for switching devices of Local Area Network of claim 9, wherein the process of the user leaving the multicast group comprises:
K) the managing device sending a general query message to side ports of users within a specified time, the switching device transmitting the message to users after receiving the message;
L) if the managing device sends general query message but does not receive a REPORT message of some multicast group within a specified time, the managing device deleting the multicast group; and
M) when the managing device receives the request message of leaving multicast group, the managing device sending down corresponding query message of multicast group, if a REPORT message is not received within a specified time, the managing device deleting the multicast group.

12. The integrated managing method for switching devices of Local Area Network of claim 9, wherein the process of the switching device transmitting a two-layered multicast message comprises:
N) the managing device transmitting the multicast message to the switching device; and
O) the switching device determining whether it can transmit the multicast message, if not, losing the message, otherwise transmitting the message to other ports except those receiving the multicast message.
